(19) United States
(12) Patent Application Publication
(10) Pub. No.: US 2005/0075230 A1
(43) Pub. Date: Apr. 7, 2005

(54) Method and apparatus for forming multi-sided containers

(76) Inventors: James Moshier, Reedley, CA (US); Dan Djokovic, Indianapolis, IN (US); Dan Nourian, Reedley, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 10/681,789

(22) Filed: Oct. 7, 2003

(51) Int. Cl. B31B 1/00

(52) U.S. Cl. 493/51

(57) ABSTRACT

The present invention is an apparatus for forming multi-sided containers from flat paperboard blanks without the use of a mandrel or inserted products, and which assures proper alignment of the leading and trailing edges of the container blank before adhering the first and last body panels of the blank together. The apparatus may be incorporated into any container assembly device as an alternative to a mandrel or analogous component. The interaction of numerous plows and guides eventually causes a wrapping action to occur bringing the last panel of the blank into the proximity of the first panel, but friction may cause the last panel to lag behind the first panel. A unique apparatus is provided which maintains separation between the first and last panels upon which adhesive has been applied that includes a mechanism to “catch up” any straggling panels to bring them into proper alignment. Once alignment is accomplished, the panels are pressed together and bonded by the adhesive.

### BACKGROUND OF THE INVENTION

1. Field of the Invention

The present invention relates to machines for forming containers from flat paperboard blanks, and more particularly, to a subsystem in such a machine for forming the body of a multiple-panel container from a flat blank including adhering together two panels of the blank while ensuring that the leading and trailing edges of the blank are properly aligned.

2. Description of the Prior Art

In the packaging industry, it has been found most efficient and otherwise effective to employ paperboard containers (“boxes” or “cases”) for the packing, shipment and storage of commodities such as fresh fruit, fresh vegetables and meat, pre-packaged goods (e.g. cans of soup, bottles of beverages, jars of jelly, bags of rice, cartons of cereal, etc. (“cartons”)) as well as a wide assortment of other products. Paperboard containers are comparatively inexpensive, light in weight, sufficiently strong for the prescribed usage and disposable at the ultimate destination.

Numerous paperboard containers and designs have been developed over the years along with machines for forming containers from such materials. These containers are typically constructed of a corrugated material which may be single face corrugated, single wall (double-faced) corrugated, double wall corrugated, triple wall corrugated, etc. Containers may also be made of other paperboard products including, without limitation, container board, boxboard, linerboard, and cardboard. Containers made from these materials can be produced in a variety of shapes and sizes suited to the specific prescribed uses intended. Such containers are unusually strong and durable for their cost and weight and thus are excellently suited to serving a multitude of uses. Typically, the manufacturers of such containers produce them in flattened, blank type configurations. These are sold in bulk to users that employ container forming machines to form, or erect, the containers for use. Such users may, for example, be companies that pack and sell, or distribute, any of the aforementioned commodities.

A conventional container forming machine typically receives the container blanks in bulk in a hopper, or magazine. During operation, the machine feeds each blank in succession along a path of travel, applies adhesive at pre-selected locations thereon, folds the container blank along preformed score lines and into designed container configurations, compresses portions of the container so that the adhesive adheres to retain the container in the designed configuration and finally discharges the container for use in packing the commodities involved. Such packing is normally also performed on an entirely automated basis by other equipment. It is essential in such container forming machines that the containers be formed and discharged at a high rate of speed to produce the volume of containers required during the packing operation. However, it is also required that the containers, so formed, be dependably of the design configuration required and without variation from container to container so that, for example, the packing equipment is capable of handling, packing and sealing the containers. Variation in these regards from container to container may well render such containers unsatisfactory for use because such mechanized packing equipment is dependent for proper operation in numerous respects on receiving containers only of the designated design configuration and dimensions.

Many different container styles and types have been developed over the years, each being optimally suited for one or more particular products or industries. As the designs containers have advanced, the designs of container forming machines have also become increasingly more sophisticated. As a consequence, there are increasing demands and requirements of the users of such containers for the production of containers of more complex designs better suited to particular uses.

One of the uses for such containers is for holding large flexible bags filled with fluid, such as oil or syrup. The weight of such bags, when filled with fluid, is significant, calling for uniquely shaped paperboard containers to hold the bags during storage and shipping. It has been determined that a paperboard container having more than four sides provides an optimal design for holding a large fluid-filled bag. This is because pressure from the fluid inside the bag is transmitted to the walls of the container. In three-sided or four-sided containers, significant internal gaps develop inside between the edges of the fluid-filled bags and the corners of such containers. These gaps do not provide adequate support for the fluid-filled bag, especially if the container is improperly stored or stacked, that can lead to weakening and potential rupture of the bag and spillage of its contents.

Containers (“cases”) filled with products are frequently arranged in tall stacks for convenience in storage and shipping. It is therefore desirable to provide strong cases that can be arranged into tall stacks. To obtain a stronger case typically involves providing additional side or end panels, reinforced corners, and the like. These things typically increase the size, complexity and cost of the blanks used to make the cases, and the machines needed to erect them. As a result, it has become prevalent in the packaging industry to rely on the strength of the cartons or packages that are loaded into the cases to provide stacking strength for the case. For example, a case filled with 2-liter beverage bottles may well rely on the strength of the bottles loaded inside the case to provide stacking strength for the case. Stacks of such cases are in a very real sense simply stacks of the bottles upon themselves, separated by the panels of the cases.

Unfortunately, the ever increasing cost of manufacturing product cartons and packages has resulted in the use of less material in the production of cartons, packages and bottles resulting in weaker packages with thinner walls and less stacking strength. In addition, certain product packages (e.g. disposable ketchup packets) cannot be relied upon for any stacking support. Thus, it is no longer appropriate to rely on the strength of the cartons or packages that are loaded into the cases to provide stacking strength to the cases. In the fruit and commodity industries, this has never been an acceptable practice. Thus, there is a need for cases that have reliable stacking strength independent of the products or packaging loaded into them, without unduly increasing the cost or complexity of the blanks or machines used to form them.

A preferred solution is to provide a multiple-sided container (i.e., one having four or more sides, such as 4, 5, 6, 8, 10, 12, and the like) with angled corners. Containers having more than four sides are preferred for holding fluid-filled bags because their shape tends to minimize corner gaps and resist bulging, and the angled corners of such containers provide greater all-around support and stacking strength. Unfortunately, because of the complexities in forming such containers from a flat blank, many conventional machines designed to form 4-sided containers are not suitable for use in forming containers with more than four sides. In particular, folding a flat blank into a container having more than four sides presents unusual challenges in maintaining alignment of the multiple panels of the container body during formation, and in adhering the first and last of such panels together—especially if none of the corners of the container to be formed will be right angles (90 degrees).

Containers having more than four sides, such as hexagonal and octagonal containers, are preferred because the multiple body panels of such containers provide improved stacking strength, better product stability, resistance to panel bulging that may be caused by heavy product loads, more available space for graphics and advertising, and resistance to damage from stretch wrapping.

A group of container blanks known generally as regular slotted cases (RSCs) are partially pre-formed upon manufacture, and include half slotted cases (HSCs), side load RSCs, end load RSCs, RSCs with extended manufacturers joint, and the like. RSCs are generally described as container blanks in which the leading and trailing panels of the container body have already been overlapped and adhered together by the blank manufacturer before shipment. The body panels and end flaps of RSCs are pre-scored so that forming the case involves simply opening up the body, and then folding and adhering the end panels into place. Because of the overlapping of the pre-adhered panels, “flat” RSC blanks generally have three times the thickness of a single-sheet blank resulting from the two overlapping adhered panels, and the opposite side panel of the pre-formed body. However, RSC blanks are only about half as wide as a corresponding single-sheet blank used for making the same sized container. As a result, RSC blanks are about ⅓ less efficient to store and ship than corresponding single-sheet blanks used to form like containers. When hundreds of thousands of blanks are to be stored and shipped, the inefficiency of RSCs over single-sheet blanks becomes readily apparent, making it desirable to avoid the use of RSCs if possible.

A traditional method of assembling a four-sided paperboard container from a flat blank is to first crease the blank along its fold lines to form the general container shape. The two end flaps are then folded onto the two opposite corresponding side panels so that the edges of the side panels rest snugly against the flap fold line creases. This flush position ensures a sturdy and properly formed container. The end flaps are then secured to the opposite side panels using an adhesive.

Some polygonal container forming machines have been developed. U.S. Pat. Nos. 4,932,930 and 5,147,271 disclose machines that utilize a mandrel to assemble the container. The exterior shape of the mandrel corresponds to the internal shape of the container to be formed, and one or more arms are used to wrap the flat carton blank around the mandrel. These devices are not capable of rapid production of large number of containers, and require a different mandrel for each different container type to be formed. Moreover, neither device provides adequate alignment safeguards.

U.S. Pat. No. 5,375,715 discloses a device utilizing the shape of the products (i.e. bottles) inserted into the container to form the top portion of the container, in a manner similar to that of a mandrel. A series of plows and guides fold first and second sides down over the products (i.e. bottle tops). This invention requires that the products be placed into the container blank prior to the formation process which makes the device unusable in many applications, or severely limits its usefulness, such as where the products to be packaged are in a different location than the machine forming the containers, or where the products have special handling or temperature requirements that cannot be provided in conjunction with the container forming machine. This device also has an alignment shortcoming in that it relies upon the proper initial formation of the open top container, as well as the proper placement of the goods within it for proper alignment. Errors in either area will cause the subsequent creases to be made in improper locations.

It is therefore desirable to provide a machine or sub-assembly that is capable of rapidly forming the body of a multiple-panel container from a flat blank by adhering together first and last panels of the blank while ensuring that the leading and trailing edges of the blank are properly aligned. It is also desirable to eliminate the use of a container-shaping mandrel so as to speed up the formation process, and to avoid reliance upon insertion and proper placement of the products themselves into the container as part of the container formation process.

### SUMMARY OF THE INVENTION

The present invention is an apparatus for forming multi-sided containers from flat single-sheet paperboard blanks without the use of a mandrel or inserted products, and which assures proper alignment of the leading and trailing edges of the container blank before adhering the first and last body panels of the blank together. The apparatus may be incorporated into any container assembly device as an alternative to a mandrel or analogous component. The apparatus is generally designed for use with containers having more than fours sides, but may be adapted for use in forming 4-sided as well as RSC containers.

The present invention generally comprises a plurality of various plows and guides disposed along a lateral track defined by one or more conveyor belts along which a pre-scored container blank is taken. The plows and guides are situated in specific locations along the track to form the various panels of the container blank by folding it along the pre-scored lines. As the blank travels down the track, the panels are wrapped around or “funneled” in a circular fashion to form the body of the container. The invention may be easily configured to handle any of a wide range of different numbers of panels, such that containers with virtually any number of panels (sides) may be formed. Eventually, the circular wrapping causes the last panel of the blank to come into the proximity of the first panel. Then, as described more fully hereinbelow, these two panels are adhered together to form the container body. However, before such adhesion takes place, special devices are employed to assure that all of the panels of the container are in alignment. This is because the friction between the panels of the blank and the various plows and guides may cause some of the panels to lag behind others. A unique apparatus is used to line up yet maintain separation between the first and last panels upon which adhesive has been applied while the alignment takes place. Once alignment is accomplished, the panels are pressed together and bonded by the adhesive.

In particular, one or more continuous primary conveyors are provided along the path to carry blank after blank through the machine where they encounter various guides and plows that perform several initial folds on each container blank. These primary conveyors may be provided in any appropriate form such as one or more continuous pinch belts with rollers, one or more continuous chains or belts with cleats adjustably attached thereto, or the like. Each of the primary conveyors moves at the same speed, and if cleats are used, they are deployed at regular and synchronous intervals according to the size and shape of the particular container blanks being used.

After the initial folds have been accomplished, the primary conveyors may continue moving the partially-folded container blanks forward, or may hand off the blanks to a set of one or more secondary conveyors. Alignment of the body panels then takes place followed by adhesion of the first and last panels to form a wrap. A separation bar is then provided along the path of formation, and the first and last panels of the container blank are guided into positions above and below this bar. One or more adhesive applicators are provided near the separation bar to spray or otherwise apply adhesive onto the first or last panel (or both) of the container blank after it has passed through the majority of the plows and guides, but before alignment or bonding has taken place. If used, the secondary conveyors may be provided in any appropriate form such as one or more continuous chains with cleats adjustably attached thereto, one or more continuous belts with cleats adjustably attached thereto, or the like. The secondary conveyors take over movement of the blank from the primary conveyors. Then a unique alignment apparatus is used to “catch up” the trailing edges of the container blank panels bringing them into alignment as the blank continues through the machine. Once alignment is accomplished, the separation bar terminates and the first and last panels are pressed together and bonded by the adhesive.

Accordingly, the present invention results in containers having fewer alignment defects. The unique system allows the invention to align the container side panels and back edges before applying pressure to the adhesive. Unlike the prior art disclosed above, such alignment is not dependent upon the proper initial placement of the carton underneath a mandrel or analogous component, or upon the proper placement of goods within the container.

It is therefore a primary object of the present invention to provide a machine or sub-assembly that is capable of rapidly forming the body of a multiple-panel container from a flat blank by adhering together first and last panels of the blank after ensuring that the leading and trailing edges of the blank are properly aligned.

It is also a primary object of the present invention to provide a machine or sub-assembly that is capable of rapidly forming the body of a multiple-panel container from a flat blank without the use of a container-shaping mandrel so as to speed up the formation process.

It is also a primary object of the present invention to provide a machine or sub-assembly that is capable of rapidly forming the body of a multiple-panel container from a flat blank that avoids reliance upon insertion and proper placement of the products themselves into the container as part of the container formation process.

It is also an important object of the present invention to provide a means for assembling containers that does not reply upon the proper placement of the carton blank in relation to a mandrel or other foreign object.

It is also an important object of the present invention to provide a means for assembling containers which ensures that the edges of the container are aligned properly prior to adhesion of the first and last panels of the body of the container together, thereby reducing the number of defective containers.

It is also an object of the present invention to provide a machine or sub-assembly for rapidly forming and sealing the body of a multiple-panel container from a flat or single-sheet blank having a mechanism for aligning the first and last panels of the blank before these panels are adhered together.

It is also an object of the present invention to reduce material costs and improve freight economy by providing a machine or sub-assembly for rapidly forming the body of a multiple-panel container from a flat or single-sheet blank.

It is also an object of the present invention to provide a machine or sub-assembly for rapidly forming the body of a multiple-panel container from an RSC blank.

It is also an object of the present invention to provide a machine or sub-assembly for rapidly forming multiple-panel containers having improved stacking strength, better product stability, resistance to panel bulging that may be caused by heavy product loads, more available space for graphics and advertising, an optional display window, and resistance to damage from stretch wrapping.

Additional objects of the invention will be apparent from the detailed description and the claims herein.

### BRIEF DESCRIPTION OF THE DRAWINGS

FIG. 1 is a left side perspective top view of the present invention, depicting a container blank passing through the alignment and adhesion sections of the invention, as well as a portion of the formation section.

FIG. 2 is a right side perspective top view of the invention shown in FIG. 1.

FIG. 3 is an enlarged perspective view of an embodiment of the alignment and adhesion apparatus of the present invention.

FIG. 4 is a left side perspective view of the container formation path and apparatus showing a blank passing through the formation, alignment and adhesion sections of the invention.

FIG. 5 is a set of sequences of views of a container blank showing its formation stages using the present invention from perspective, top and end views.

FIG. 6 is a set of sequences of views of a container blank showing additional formation stages from perspective, top and end views.

FIG. 7 is perspective view of the container formation path and apparatus showing the formation, alignment and adhesion sections of the invention.

FIG. 8 is a view of a representative container containing products.

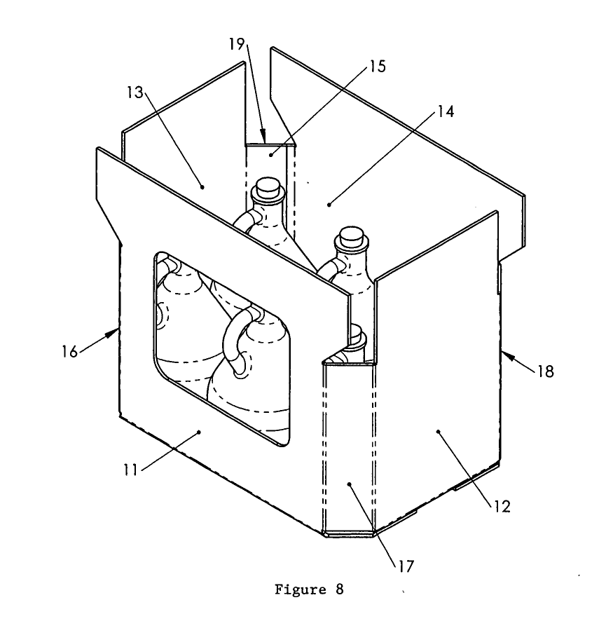

### DETAILED DESCRIPTION

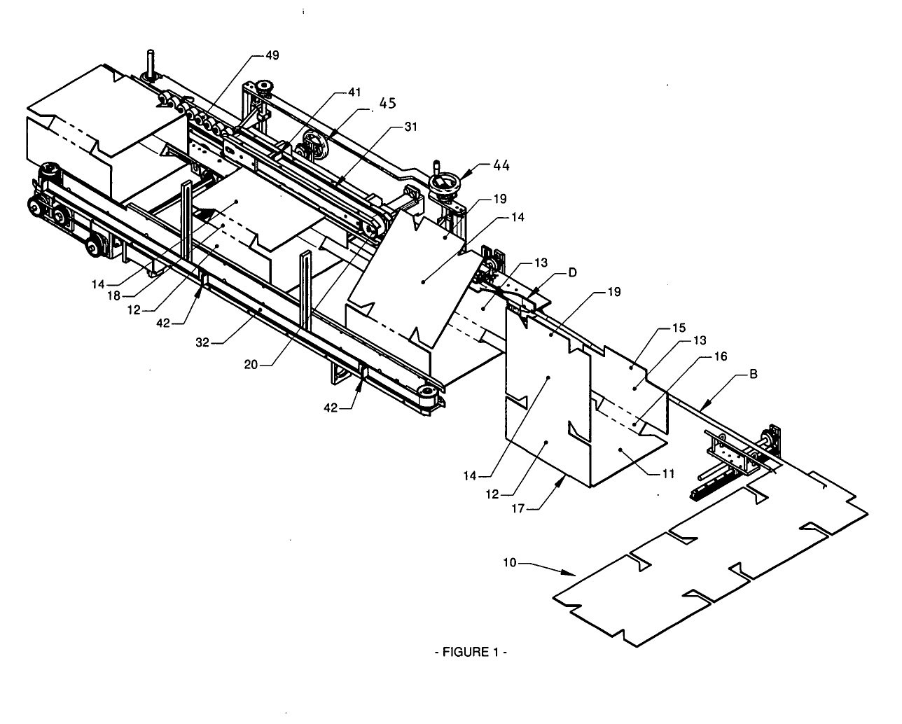

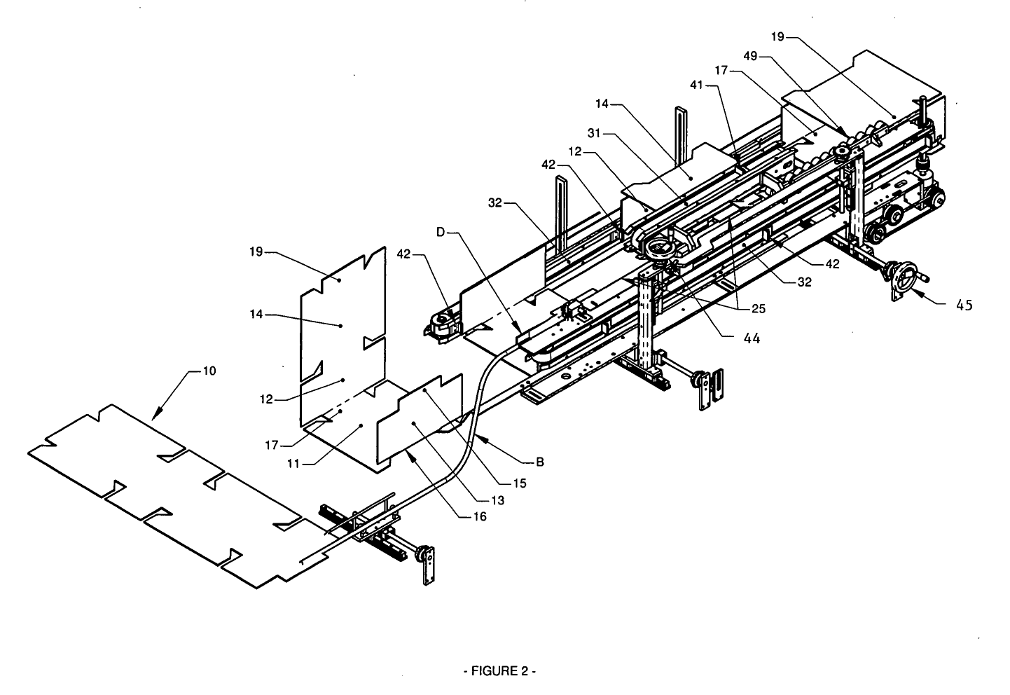

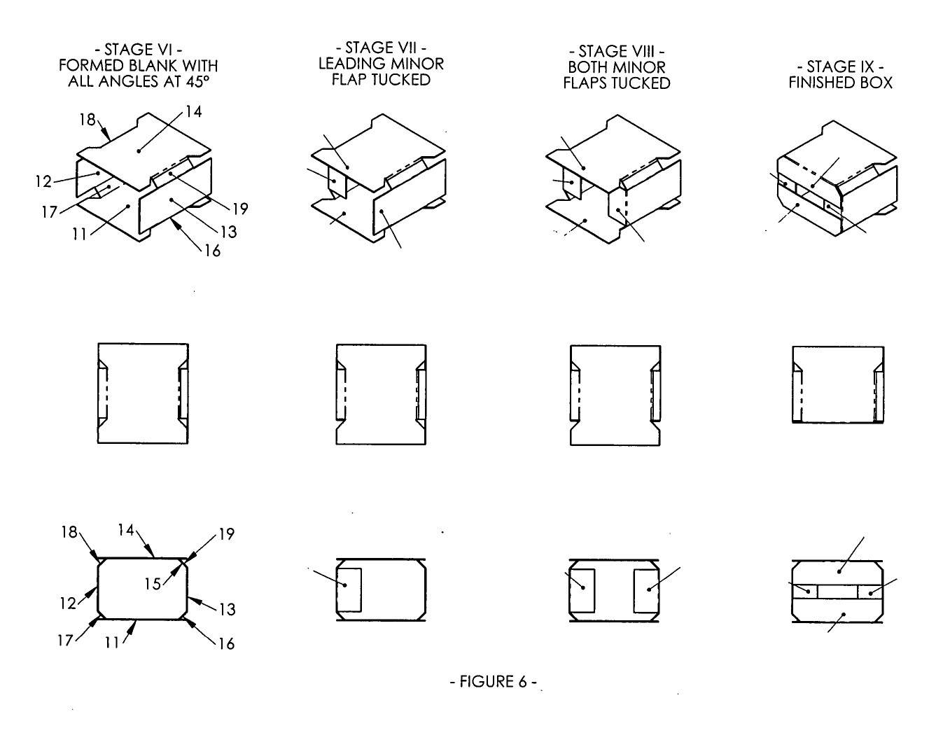

Referring to the drawings wherein like reference characters designate like or corresponding parts throughout the several views, and referring particularly to FIG. 1 it is seen that the apparatus of the present invention includes a series of plows and guides which bend, fold and wrap the plurality of panels of a container blank 10 to form the body of a container as the blank 10 is fed laterally through the machine. It is to be appreciated that the blank 10 illustrated in FIGS. 1-2 and 4-6 has eight panels such that it forms an octagonal container body, but that a blank 10 having any number of panels (e.g., 4-12, or more) could also be formed in a similar manner with minor adjustments to the plows and guides of the machine.

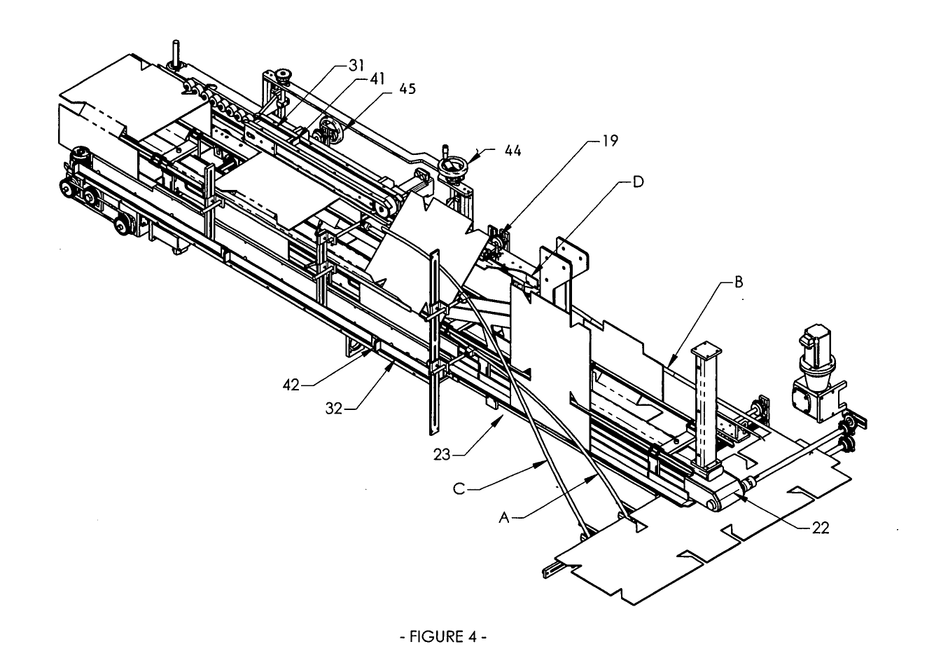

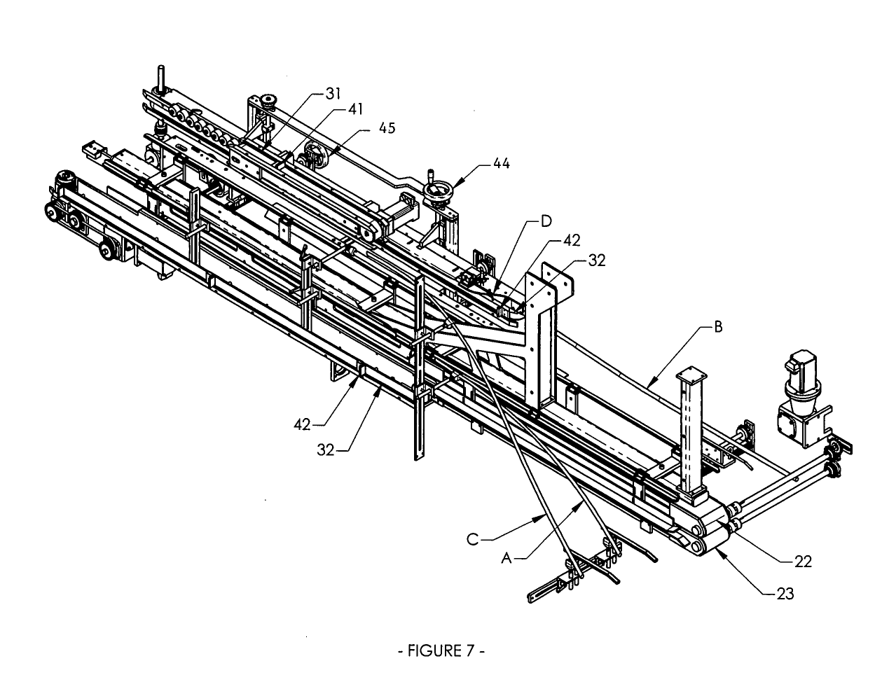

In the example illustrated in FIG. 4, blank 10 is urged forward laterally through the machine by the primary conveyors 22. The exemplary embodiment of FIGS. 4 and 7 illustrates primary conveyors 22 as a pair of pinch belts 22 and 23, however it is to be appreciated that any appropriate conveyance means may be used including without limitation, belts or chains having adjustably removable cleats located at appropriate intervals thereon. Pinch belts are preferred over cleats as the primary conveyors 22 because pinch belts avoid damaging the blank as it encounters frictional resistance from the forming plows and guides. Such frictional resistance could cause cleats to impart dents or deformities to the blank, whereas pinch belts allow some slippage of the blank 10 without damaging it, while maintaining throughput of blanks through the machine. This slippage is compensated for in the alignment section of the invention, as discussed more fully below. As it is moved through the machine, the container blank 10 encounters a series of inner and outer plows and guides (A-D) which bend, fold and wrap the various panels of the blank in a circular or funnel fashion.

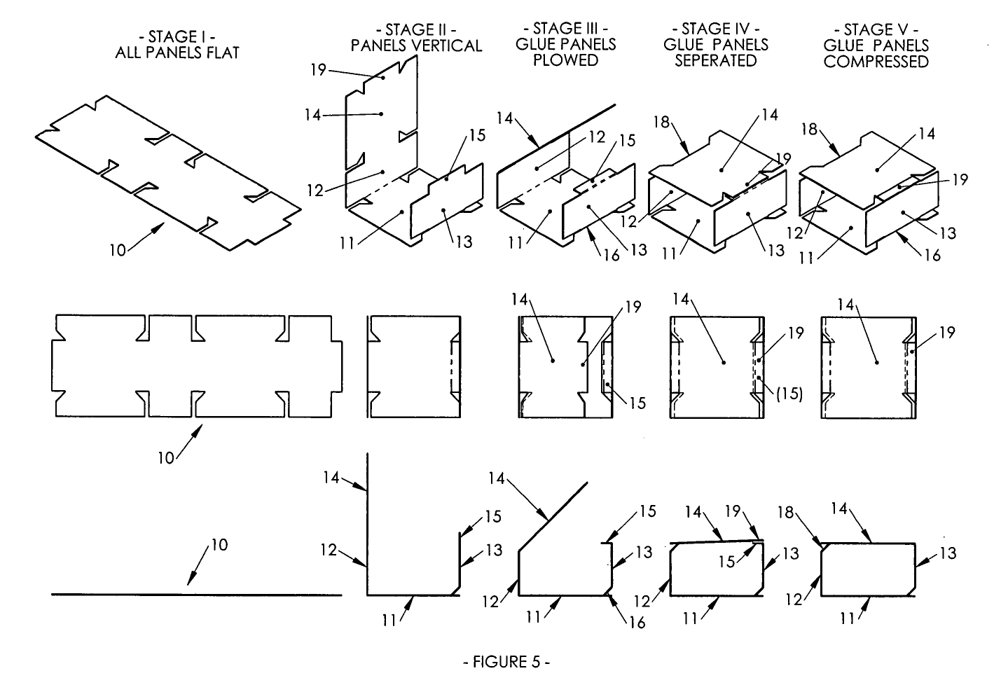

The various stages of folding experienced by this exemplary blank are illustrated in FIG. 5. First, side panel 12 including attached top panel 14 is initially bent upward to a generally vertical position by side plow bar A. At about the same time, second side panel 13 is also bent into a generally vertical position by side plow bar B. See FIG. 4, and Stage 1I of FIG. 5. Next, plow bar C folds top panel 14 down to an angled position. See FIG. 4. At about the same time, an intermediate end panel 15 attached to side panel 13 is bent from vertical to horizontal by plow bar D. These two folds are shown at Stage III of FIG. 5. These major folds are preferably accomplished while blank 10 is being propelled only by the primary pinch belt conveyors 22 so as to avoid any potential damage to blank 10 that may result from cleats pressing against blank 10 during the frictional resistance imparted by plows A-D.

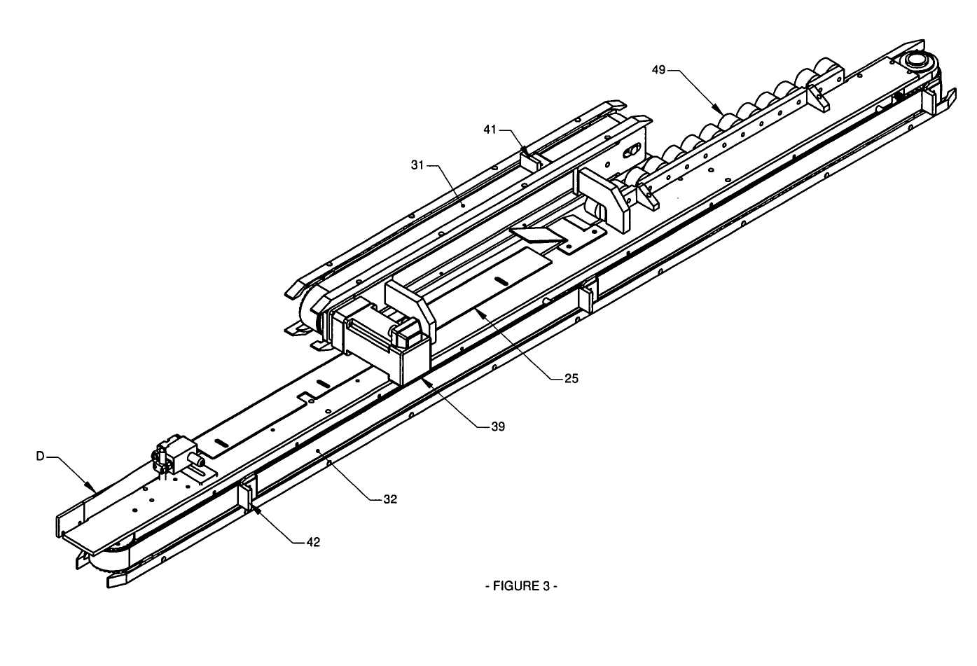

In the illustrated embodiment, as blank 10 continues moving forward it is handed off to a set of one or more secondary conveyors 32. In the exemplary embodiment illustrated in FIGS. 1-4 and 7, it is seen that these secondary conveyors 32 are provided on either side of the path of the blank 10 defined by the primary conveyors 22. Secondary conveyors 32 are provided with adjustably positionable cleats 42 for engagement with the now up-folded side panels 12 and 13 of blank 10. The positions of cleats 42 on conveyors 32 may be adjusted according to the size, spacing and style of the particular container blanks 10 introduced into the invention. If multiple secondary conveyors 32 are used, each of cleats 42 is synchronized on its respective conveyor 32 so that each cleat 42 engages the back edge of its respective panel on the same plane so as to maintain all of panels 11-13 in alignment with each other.

Top panel 14 (with attached intermediate panel 19) is next folded to a generally horizontal position as shown at Stage 1V of FIG. 5. This activity results in the position of intermediate panel 19 attached to top panel 14 being located in a spaced relationship above intermediate end panel 15 of panel 13. These two intermediate panels (19 and 15) will eventually be adhered together to form a continuous body or wrap of the formed container. It is to be appreciated that blank 10 may have any number of panels (in the illustrated example, there are eight such panels), and that plows and guides may be added, removed and/or adjusted according to the given number of panels so that the first and last panels (in the illustrated example, intermediate panels 15 and 19) are positioned above each other in a spaced relationship prior to adhesion. It is also to be appreciated that the primary and secondary conveyors, and any cleats located thereon, may also be adjusted according to the size, style and spacing of the particular container blanks 10 introduced into the machine.

Between stages I-IV, the friction between plow bars A, B, C and D against respective panels 12, 13, 14 and 15 may cause panels 14 and 19 to drag slightly such that they lag behind side panels 12 and 13 which are being propelled forward by cleats 42 on secondary side conveyors 32. The larger the container blank, the larger the panels, the greater the surface area and distance from the first panel to the last panel, and the more pronounced the potential frictional lag of the most remote panels (e.g. 14 and 19) from the panels closest (e.g. 12 and 13) to the conveyors 22 and 32. For some container blanks, this lag may be as much as two inches. Because of this friction, it is important to assure that main panels 11-14, and particularly the intermediate panels 15 & 19 are properly aligned before they are adhered to each other. The position of panel 11 is not of concern in the illustrated embodiment since it is located between panels 12 and 13 which are being moved synchronously by aligned cleats 42 on secondary conveyors 32. However, this may not necessarily be the case in a different embodiment with different conveyors contacting different panels.

The adhesion and alignment is accomplished by first applying longitudinal beads or strips of adhesive to the top of lower panel 15 (or the bottom of upper panel 19, or both) while keeping lower panel 15 spatially separated from upper panel 19 until alignment occurs. This separation is accomplished using a separating member such as a bar or rod 25 positioned between panels 15 and 19 that extends for a short distance along the path through the machine, after plow D has bent panel 14 down. Over this critical span that includes but extends beyond member 25, one or more additional alignment devices 31 are provided to engage the trailing edge(s) of one or more of the now bent panels (e.g. 12, 13 and/or 14 in the illustrated embodiment) of blank 10 to bring them into alignment with the back edge of the remaining panels (e.g. bottom panel 11).

In the illustrated embodiment, one or more alignment conveyors 31 are provided along the critical span of the longitudinal path of the container blank 10 through the machine including and extending beyond separating member 25. Each alignment conveyor 31 is a continuous motor-operated belt that is provided with a plurality of adjustably positionable cleats 41 located thereon at spaced intervals. These intervals may be the same as, or different from those of cleats 42 on secondary conveyors 32. In the illustrated embodiment, alignment conveyor 31 is mounted above the path of the container blank so that each cleat 41 engages the trailing edge of a top panel 14. Additional conveyors 31 may also be provided along the same critical section of the longitudinal path, each additional alignment conveyor 31 having, respectively, a plurality of cleats 41 located thereon at the same spaced intervals. It is to be appreciated that one or more alignment conveyors 32 may be provided at any suitable location along the path of blank 10 in order to engage any panels of the blank 10 that may potentially be trailing as a result of frictional resistance discussed above.

Each alignment conveyor 31 is independently operable from the primary 22 and, if used, secondary conveyors 32. When multiple alignment conveyors 31 are used, they are synchronized with each other. Alignment conveyors 31 do not always operate at the same speed as primary and secondary conveyors 22 and 32. In the illustrated embodiment, a single alignment conveyor 31 is provided in a preferred location above the path of container blank 10. After blank 10 has been folded as described in stage IV, after adhesive has been applied, and while panels 15 and 19 are being held apart by member 25, the alignment conveyor(s) 31 come into use.

Alignment conveyors 31 pause briefly while the trailing edges of panels 12 and 13 are moved forward by secondary conveyors 32 to a position where those trailing edges (and cleats 42) have moved a short distance past the beginnings of the alignment conveyors 31. This delay is provided to compensate for the possible lag of panel 14 caused by the frictional resistance described previously, and allows potentially lagging panel 14 to also move past the beginnings of the alignment conveyors 31. Once this position is reached (i.e., cleats 42 have traveled a short distance past the beginnings of alignment conveyors 31), alignment conveyors 31 are activated and initially move more quickly than primary and secondary conveyors 22 and 32 in order to “catch up” with them. Servo or other similar motors may be used to accomplish this movement. This quick movement causes cleat(s) 41 to engage the trailing edge(s) of any potentially lagging panel(s) (e.g., panel 14) and bring them into alignment with the remaining panels of the blank 10. Once alignment cleats 41 have caught up with and are in alignment with secondary conveyor cleats 42, the lagging panel(s) are in alignment with the other major panels of the blank 10, and the speed of alignment conveyors 31 is reduced to match that of secondary conveyors 32. In the illustrated embodiment, panels 15 and 19 are now directly above/below each other.

Once alignment has been achieved, panels 15 and 19 move forward past the termination of separation member 25, and encounter a compression mechanism on the path. This compression mechanism may take any appropriate form (such as rollers 49 in the illustrated embodiment) which compresses intermediate panel 19 against intermediate panel 15 so that the adhesive between these panels joins them firmly together. This adhesion does not occur until all major panels of the container blank are in alignment, transforming the container blank into a large open sleeve or wrap made up of multiple adjoining panels.

In the illustrated embodiment, first and last panels 15 and 19 are maintained in a parallel, generally horizontal position during the alignment and compression operations so as to assure proper and complete adhesion. However, the invention may be set up such that the first and last panels are maintained in some other position (vertical, angled, etc.) during alignment and compression operations, so long as they are parallel to each other. After adhesion, and during later formation processes these panels may then be bent at any appropriate angle.

The positions of alignment conveyors 31 and pressure rollers 49 are adjustable so as to accommodate different sized container blanks 10. In the illustrated embodiment, the carriage assembly supporting conveyor 31 and rollers 49 may be adjusted upward or downward by rotating adjustment screw 44, and it may be rotated forward or backward using adjustment screw 45. The amount of adjustment will depend upon the size and shape of the container blank 10 to be used.

It is important to recognize that there is a critical point along the formation path through the machine at and after which the one or more alignment devices 31 should make contact with panels of the container blank 10. The major folds of the container blank 10 should be accomplished before this point, and sufficient space allowed for any lagging panels to also pass the point before alignment devices 31 are activated. Alignment devices 31 must first wait until all of the panels of blank 10, including any that may lag behind because of the friction of the formation process, have moved beyond the crucial point. This generally means waiting longer than the time necessary for the panels immediately adjacent to the secondary conveyors 32 to reach the critical point, the amount of delay (space) depending upon the size and shape of the particular container. The remote panels of larger container blanks with larger panels and more surface area (i.e., generating more frictional resistance) are likely to have a more pronounced lag than those of smaller containers with smaller panels and less surface area. When sufficient time or movement has occurred to assure that all panels have passed the crucial point, the alignment devices 31 are activated and quickly “catch up” with the secondary conveyors 32, and in the process they bring the lagging panels of the container blank 10 into alignment with the other panels of the blank.

It is to be appreciated that the “catch up” process of the alignment conveyors may be accomplished using a variety of different devices, and that one or more of such devices may be deployed at any suitable position or location along the path of formation, including without limitation, above, below, at one or more corners, or along one or more sides of said path. In one alternative embodiment, one or more pneumatic or hydraulic cylinders may be utilized in conjunction with one or more conveyors. In this embodiment, once all panels of the blank 10 have passed the critical point, the cylinder is activated which causes an associated contact element to be quickly extended out in parallel with the path of blank 10 such that the element pushes against a frictionally trailing panel of the blank 10. This movement causes the trailing panel to catch up with the remaining panels of the blank, at which point an additional conveyor engages this panel to keep it in alignment.

The “catch up” alignment device may alternatively take the form of one of numerous other embodiments that cause the necessary lurch which brings the remote panel into phase/alignment with the remaining panels, such as: a timing belt, a pulsing servo motor attached to a conveyor, a powered wheel and rail system, pinch belts, bottom rollers with tabs, adjustably cleated chains or belts (as illustrated), suction cups along the path, a drum system, or the like.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

1. An apparatus for forming the body of a multiple-sided container from a flat pre-scored blank comprising:
a. at least one first conveyor defining a path of travel for said blank through said apparatus;
b. a plurality of plows deployed along said path for folding said blank as said first conveyor moves it along said path such that a first and last panel of said blank are positioned in a parallel spaced relationship to each other;
c. an adhesive sprayer located along said path downstream from said plows for applying adhesive to one of said first and last panels;
d. a separating bar located along said path downstream from said applicator for holding said first and second panels apart after adhesive has been applied;
e. at least one alignment conveyor located along said path adjacent to said separating bar that engages a trailing panel of said blank; and
f. a compression roller located along said path downstream from said separating member and said alignment conveyor for pressing said first and last panels together.

2. The apparatus of claim 1 wherein said alignment conveyor engages one of said first and last panels of said blank to bring it into alignment with the other panels of said blank.

3. The apparatus of claim 1 wherein said alignment conveyor engages one of said first and last panels of said blank to bring said first and last panels into alignment with each other.

4. The apparatus of claim 1 wherein said alignment conveyor is at least one continuous belt with a plurality of adjustably positionable cleats located thereon for engagement with a trailing edge of a panel of said blank, said belt being attached to a motor that is capable of changing speeds to quickly catch up with said first conveyor and thereafter match the speed of said first conveyor.

5. The apparatus of claim 4 wherein said first conveyor is at least one motorized pinch belt.

6. The apparatus of claim 1 wherein at least one secondary conveyor is provided along said path downstream from said first conveyor in the vicinity of said separating member wherein said container blank is transferred from said first conveyor to said secondary conveyor as it travels through said apparatus.

7. The apparatus of claim 4 wherein said alignment conveyor is provided above said path.

8. An apparatus for forming the body of a multiple-sided container from a flat pre-scored blank comprising:
a. at least one first conveying means defining a path of travel for said blank through said apparatus;
b. a plurality of panel deforming means deployed along said path for folding said blank as said first conveyor moves it along said path such that a first and last panel of said blank are positioned in a parallel spaced relationship to each other;
c. an applicator means located along said path downstream from said plows for applying adhesive to one of said first and last panels;
d. a separating means located along said path downstream from said applicator means for holding said first and second panels apart after adhesive has been applied to one of said first and last panels;
e. at least one moveable alignment means located along said path adjacent to said separating means for engaging a trailing panel of said blank to bring it into alignment with the other panels of said blank; and
f. a compression means located along said path downstream from said separating means and said alignment means for pressing said first and last panels together.

9. The apparatus of claim 8 wherein said alignment means comprises a reciprocating cylinder having an associated contact element for engagement with a panel of said blank to bring it into alignment with the other panels of said blank.

10. The apparatus of claim 8 wherein said alignment means is selected from the group consisting of: a timing belt, a pulsing servo motor attached to a conveyor, a powered wheel and rail system, at least one pinch belt, at least one bottom roller with tabs, adjustably cleated chains, selectably operable suction cups, and a drum system.

11. The apparatus of claim 8 wherein said applicator means comprises a sprayer.

12. The apparatus of claim 8 wherein said separating means is selected from the group consisting of a longitudinal rod and a longitudinal bar.

13. The apparatus of claim 1 wherein said compression means is comprised of a plurality of pressure rollers.

14. A method for forming the body of a multiple-sided container from a flat blank comprising the steps of:
a. conveying said blank along a formation path through a machine;
b. folding said blank using a plurality of plows deployed along said path such that a first and last panel of said blank are positioned in a parallel spaced relationship to each other;
c. applying adhesive to one of said first and last panels;
d. keeping said first and last panels separated from each other after said adhesive has been applied and while alignment is taking place;
e. engaging a trailing panel of said blank using an alignment conveyor located along said path to bring said trailing panel into alignment with the other panels of said blank while maintaining separation between said first and last panels; and
f. compressing said first and last panels together after alignment has been accomplished.

15. The method of claim 14 comprising the additional step of bringing said first and last panels into alignment with each other.

16. The method of claim 14 comprising the additional step of transferring said blank from a first conveyor to a secondary conveyor after it has been folded by said plurality of plows.

17. The method of claim 14 wherein said alignment conveyor causes said trailing panel to catch up with the remaining panels of said blank.
